(19) United States
(12) Patent Application Publication
(10) Pub. No.: US 2014/0191930 A1
(43) Pub. Date: Jul. 10, 2014

(54) DISPLAY DEVICE AND INSPECTION METHOD THEREOF

(71) Applicant: MITSUBISHI ELECTRIC CORPORATION, Tokyo (JP)

(72) Inventor: Kazunori OKUMOTO, Tokyo (JP)

(73) Assignee: MITSUBISHI ELECTRIC CORPORATION, Tokyo (JP)

(21) Appl. No.: 14/145,340

(22) Filed: Dec. 31, 2013

(30) Foreign Application Priority Data
Jan. 10, 2013 (JP) 2013-002213

(51) Int. Cl. G09G 3/00

(52) U.S. Cl. CPC G09G 3/006
USPC 345/55

(57) ABSTRACT

A display device has a substrate provided with a display region and first and second semiconductor chip mounting regions. Channel widths of first and second lead-wiring-line disconnection inspection TFTs provided in the first and second semiconductor chip mounting regions are smaller than channel widths of first and second inspection TFTs provided other than in the display region and the first and second semiconductor chip mounting regions.

### BACKGROUND OF THE INVENTION

1. Field of the Invention

The present invention relates to a display device provided with a plurality of semiconductor switching elements, and an inspection method thereof.

2. Description of the Background Art

There is known a technique for inspecting disconnection of a gate signal line and a source signal line, a pixel defect, and the like in semiconductor switching elements provided in a display region of a display panel included in a display device, by means of lighting/non-lighting of the pixels of the display panel. As one of the inspection techniques, there is known a technique of bringing an inspection needle into contact with an inspection terminal, and then batch-controlling inputs of inspection signals into a plurality of gate signal lines and source signal lines by means of a plurality of inspection semiconductor switching elements connected with those signal lines, to inspect the plurality of gate signal lines and source signal lines in a batch.

According to such a batch inspection technique, differently from an inspection technique of individually probing terminals of the plurality of gate signal lines and source signal lines, an inspection device is free from being influenced by a resolution of the display panel and a design (e.g., the number of bumps) of a semiconductor chip, thus allowing realization of generic, inexpensive inspection.

It is to be noted that in the above inspection technique, conventionally a lighting inspection circuit including the above plurality of inspection semiconductor switching elements and the like was provided in a semiconductor chip mounting region where a semiconductor chip is mounted. However, with reduction in size of the semiconductor chip and narrowing of a picture frame of the display panel, it became necessary to reduce a size of the semiconductor chip mounting region, and hence it was thought of dividing the lighting inspection circuit into a plurality of parts and providing them in regions other than the semiconductor chip mounting region.

However, there then occurred a problem of being unable to inspect disconnection of lead wiring lines that connect between the semiconductor chip mounting region and the display region. In order to solve this problem, there is proposed a technique of providing an inspection circuit only aimed at inspecting disconnection of the lead wiring lines in the semiconductor chip mounting region (for example, Japanese Patent Application Laid-Open No. 2011-154161).

### SUMMARY OF THE INVENTION

As thus described, there is a tendency of reduction in size of a semiconductor chip, and for example, and a distance (length of a short side of the semiconductor chip) between each of a plurality of output bumps provided on one of two long sides of the semiconductor chip and each of input bumps provided on the other long side becomes smaller. This tendency can be said to be preferable for narrowing of the picture frame of the display panel.

However, in order to narrow the picture frame of the display panel, it is necessary to reduce not only the size of the semiconductor chip but also the size of the above semiconductor chip mounting region where the semiconductor chip is mounted (particularly necessary to shorten a distance between an input terminal and an output terminal connected with the input bump and the output bump). However, since a variety of circuits and wiring lines such as wiring lines for connecting the input bumps have already been provided in a normal semiconductor chip mounting region, when the inspection circuit for inspecting the lead wiring lines as in Japanese Patent Application Laid-Open No. 2011-154161 is provided in the semiconductor chip mounting region without some contrivance, reducing the size of the semiconductor chip mounting region is considered impossible.

The present invention was made to solve the problem as described above, and an object thereof is to provide a technique capable of reducing a size of a semiconductor chip mounting region.

The present invention is a display device having a substrate provided with a display region and semiconductor chip mounting regions. The display region is provided with a plurality of semiconductor switching elements, a plurality of gate signal lines connected with gate electrodes of the plurality of semiconductor switching elements, and a plurality of source signal lines connected with source electrodes of the plurality of semiconductor switching elements. The semiconductor chip mounting regions are provided with a plurality of first output terminals and a plurality of second output terminals which are output terminals connected with semiconductor chips and are respectively connected with the plurality of gate signal lines and the plurality of source signal lines via a plurality of first and second lead wiring lines. The display device is provided with a plurality of first inspection semiconductor switching elements which are provided on the substrate other than the display region and the semiconductor chip mounting regions and can batch-control inputs of inspection signals into the plurality of gate signal lines in accordance with a commonly applied gate potential, and a plurality of second inspection semiconductor switching elements which are provided on the substrate other than the display region and the semiconductor chip mounting regions and can batch-control inputs of inspection signals into the plurality of source signal lines in accordance with a commonly applied gate potential. Further, the display device is provided with a plurality of first lead-wiring-line disconnection inspection semiconductor switching elements which are provided in the semiconductor chip mounting region and can batch-control inputs of inspection signals into the plurality of gate signal lines via the plurality of first output terminals and the plurality of first lead wiring lines in accordance with a commonly applied gate potential, and a plurality of second lead-wiring-line disconnection inspection semiconductor switching elements which are provided in the semiconductor chip mounting region and can batch-control inputs of inspection signals into the plurality of source signal lines via the plurality of second output terminals and the plurality of second lead wiring lines in accordance with a commonly applied gate potential. A channel width of each of the first lead-wiring-line disconnection inspection semiconductor switching elements is smaller than a channel width of each of the first inspection semiconductor switching elements, and a channel width of each of the second lead-wiring-line disconnection inspection semiconductor switching elements is smaller than a channel width of each of the second inspection semiconductor switching elements.

It is possible to reduce the channel widths of the plurality of first and second lead-wiring-line disconnection inspection semiconductor switching elements, thereby making sizes of the semiconductor switching elements small. Hence, it is possible to make small sizes of the semiconductor chip mounting regions provided with the plurality of first and second lead-wiring-line disconnection inspection semiconductor switching elements.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a configuration of a display device according to a first preferred embodiment;

FIGS. 2A, 2B, 2C and 2D are diagrams each showing an inspection method of a display device according to the first preferred embodiment;

FIGS. 3A and 3B are enlarged plan views each showing a configuration of a display device according to a second preferred embodiment;

FIG. 4 is a circuit diagram showing a configuration of a display device according to a third preferred embodiment;

FIG. 5 is an enlarged plan view showing a configuration of a display device according to a fourth preferred embodiment; and

FIG. 6 is an enlarged plan view showing a configuration of a display device according to a fifth preferred embodiment.

### DESCRIPTION OF THE PREFERRED EMBODIMENTS

### First Preferred Embodiment

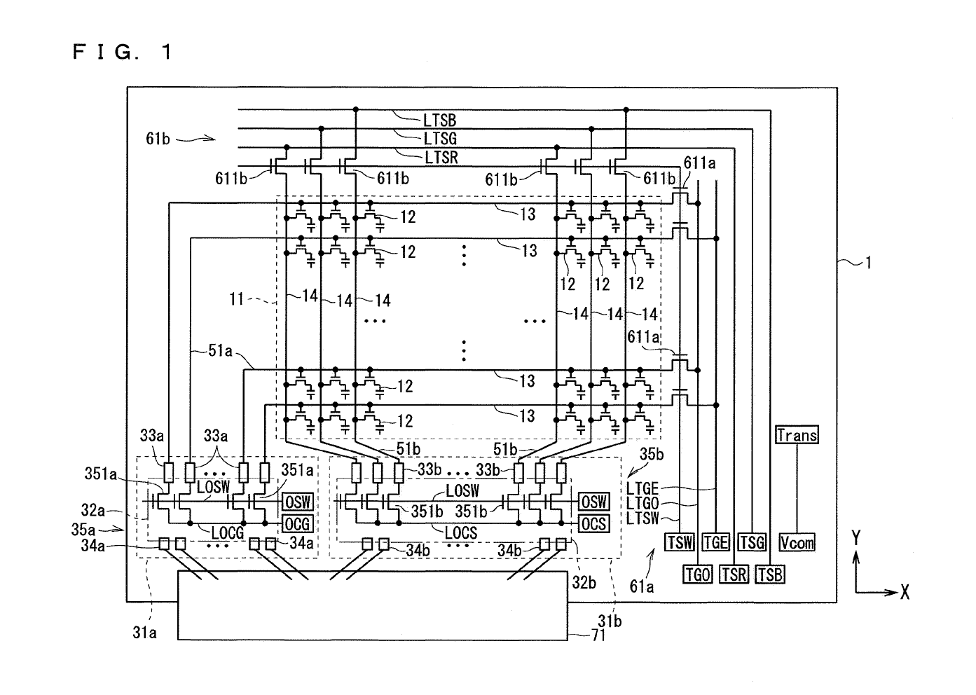

FIG. 1 is a circuit diagram showing a configuration of a display device (display panel) according to a first preferred embodiment of the present invention. It is to be noted that a reference numeral of each constitutional element of the display device according to the first preferred embodiment shown in FIG. 1 is also provided to an identical or similar constitutional element of display devices according to other preferred embodiments.

As shown in FIG. 1, the display device according to the first preferred embodiment includes: a substrate 1 provided with a display region 11 and semiconductor chip mounting regions (here, first and second semiconductor chip mounting regions 31a, 31b) indicated by broken lines; and a gate drive circuit 32a and a source drive circuit 32b indicated by two-dot chain lines.

The display region 11 is provided with a plurality of switching elements (here, a plurality of display TFTs (Thin Film Transistors) 12) arrayed in a matrix form, a plurality of gate signal lines 13 connected with gate electrodes of the plurality of display TFTs 12, and a plurality of source signal lines 14 connected with source electrodes of the plurality of display TFTs 12. It is to be noted that the plurality of gate signal lines 13 are extended in an X-direction and arrayed in a Y-direction, and the plurality of source signal lines 14 are extended in the Y-direction and arrayed in the X-direction.

The first semiconductor chip mounting region 31a is a region where a semiconductor chip (here, a gate drive circuit 32a) is to be mounted. This first semiconductor chip mounting region 31a is provided with: a plurality of first output terminals 33a connected with output bumps (not shown) of the gate drive circuit 32a; a plurality of first input terminals 34a connected with input bumps (not shown) of the gate drive circuit 32a; and a first lead-wiring-line disconnection inspection circuit 35a, which is to be described later.

As shown in FIG. 1, the plurality of first output terminals 33a are respectively connected with the plurality of gate signal lines 13 in the display region 11 via the first lead wiring lines 51a, and the plurality of first input terminals 34a are electrically connected with a drive circuit 71.

With such a configuration, the drive circuit 71 outputs drive signals to the gate drive circuit 32a via the plurality of first input terminals 34a, and in response to the drive signals, the gate drive circuit 32a controls (drives) the plurality of display TFTs 12 via the plurality of first output terminals 33a and first lead wiring lines 51a, and the like.

Next, the second semiconductor chip mounting region 31b will be described. The second semiconductor chip mounting region 31b is a region where a semiconductor chip (here, a source drive circuit 32b) is to be mounted. As in the first semiconductor chip mounting region 31a, the second semiconductor chip mounting region 31b is provided with: a plurality of second output terminals 33b connected with output bumps (not shown) of the source drive circuit 32b; a plurality of second input terminals 34b connected with input bumps (not shown) of the source drive circuit 32b; and a second lead-wiring-line disconnection inspection circuit 35b, which is to be described later.

As shown in FIG. 1, the plurality of second output terminals 33b are respectively connected with the plurality of source signal lines 14 in the display region 11 via the second lead wiring lines 51b, and the plurality of second input terminals 34b are electrically connected with the drive circuit 71.

With such a configuration, the drive circuit 71 outputs drive signals to the source drive circuit 32b via the plurality of second input terminals 34b, and in response to the drive signals, the source drive circuit 32b controls (drives) the plurality of display TFTs 12 via the plurality of second output terminals 33b and second lead wiring lines 51b, and the like.

According to the display device in accordance with the first preferred embodiment as above, the gate drive circuit 32a and the source drive circuit 32b control (drive) the plurality of display TFTs 12 provided in the display region 11 in response to the drive signals from the drive circuit 71. Therefore, the display device according to the first preferred embodiment can display a desired image in the display region 11.

This display device (display panel) not only includes the first and second lead-wiring-line disconnection inspection circuits 35a, 35b in the first and second semiconductor chip mounting regions 31a, 31b, but also includes first and second lighting inspection circuits 61a, 61b on the substrate 1 other than the display region 11 and the first and second semiconductor chip mounting regions 31a, 31b.

Briefly describing these inspection circuits 61a, 61b, 35a, 35b, the first and second lighting inspection circuits 61a, 61b can inspect disconnection and short circuits of the plurality of gate signal lines 13 and source signal lines 14 provided in the display region 11, a pixel defect (bright spot, black spot), display nonuniformity, and the like. Meanwhile, the first and second lead-wiring-line disconnection inspection circuits 35a, 35b can inspect disconnection and the like as to the first and second lead wiring lines Ma, 51b respectively which connect the display region 11 with the first and second semiconductor chip mounting regions 31a, 31b. Next, details of the first and second lighting inspection circuits 61a, 61b and the first and second lead-wiring-line disconnection inspection circuits 35a, 35b will be described in this order.

<First Lighting Inspection Circuit 61a>

The first lighting inspection circuit 61a provided on the +X side from the display region 11 includes one L-shaped inspection signal line LTSW that has a portion extended in the Y-direction and a portion extended in the X-direction, two inspection signal lines LTGO, LTGE extended in the Y-direction, and a plurality of first inspection semiconductor switching elements (here, a plurality of first inspection TFFs 611a) arrayed in the Y-direction.

The portion of the inspection signal line LTSW which is extended in the Y-direction is connected with a terminal TSW, while being connected commonly with the gate electrodes of the plurality of first inspection TFTs 611a.

The inspection signal line LTGO as the first inspection signal line is connected with a terminal TGO, while being connected with the odd-numbered gate signal lines 13 from the upper side (+Y side) out of the plurality of gate signal lines 13 in the display region 11 via the first inspection TFTs 611a.

The inspection signal line LTGE as the first inspection signal line is connected with a terminal TGE, while being connected with the even-numbered gate signal lines 13 from the upper side (+Y side) out of the plurality of gate signal lines 13 in the display region 11 via the first inspection TFTs 611a.

The plurality of first inspection TFTs 611a can batch-control inputs (non-inputs) of inspection signals from the terminals TGO, TGE (inspection signal lines LTGO, LTGE) into the plurality of gate signal lines 13 in accordance with a gate potential commonly applied from the terminal TSW (inspection signal line LTSW). It is to be noted that the configuration described above is an example and not restricted to this, and the number, an orientation, a shape and the like of constitutional element of the first lighting inspection circuit 61a may be changed as appropriate.

<Second Lighting Inspection Circuit 61b>

The second lighting inspection circuit 61b provided on the +Y side from the display region 11 includes the L-shaped inspection signal line LTSW described above, three inspection signal lines LTSR, LTSG, LTSB each having a portion extended in the Y-direction and a portion extended in the X-direction, and a plurality of second inspection semiconductor switching elements (here, a plurality of second inspection TFFs 611b) arrayed in the X-direction.

The portion of the inspection signal line LTSW which is extended in the X-direction is connected commonly with the gate electrodes of the plurality of second inspection TFTs 611b. Besides these, since the portion of the inspection signal line LTSW which is extended in the Y-direction is connected commonly with the gate electrodes of the plurality of first inspection TFTs 611a as described above, the inspection signal line LTSW can apply common gate potentials to the plurality of first and second inspection TFTs 611a, 611b.

The inspection signal line LTSR as the second inspection signal line is connected with a terminal TSR, while being connected with the source signal line 14 concerning a red pixel out of the plurality of source signal lines 14 in the display region 11 via the second inspection TFT 611b.

The inspection signal line LTSG as the second inspection signal line is connected with a terminal TSG, while being connected with the source signal line 14 concerning a green pixel out of the plurality of source signal lines 14 in the display region 11 via the second inspection TFT 611b.

The inspection signal line LTSB as the second inspection signal line is connected with a terminal TSB, while being connected with the source signal line 14 concerning a blue pixel out of the plurality of source signal lines 14 in the display region 11 via the second inspection TFT 611b.

The plurality of second inspection TFTs 611b can batch-control inputs (non-inputs) of inspection signals from the terminals TSR, TSG, TSB (inspection signal lines LTSR, LTSG, LTSB) into the plurality of source signal lines 14 in accordance with a gate potential commonly applied from the terminal TSW (inspection signal line LTSW). It is to be noted that the configuration described above is an example and not restricted to this, and the number, an orientation, a shape and the like of constitutional element of the second lighting inspection circuit 61b may be changed as appropriate.

According to the first and second lighting inspection circuits 61a, 61b as described above, when an on-voltage gate potential is applied to the terminal TSW, the plurality of first and second inspection TFTs 611a, 611b come into an on-state in a batch. In this case, it is possible to respectively input the inspection signals from the terminals TGO, TGE into the odd numbered and even numbered gate signal lines 13, and it is possible to respectively input the inspection signals from the terminals TSR, TSG, TSB into the red-pixel, green-pixel and blue-pixel source signal lines 14. Therefore, when the inspection signals are inputted into a large number of gate signal lines 13 and source signal lines 14 in a batch, by focusing attention on whether or not a desired pixel is lighted, it is possible to inspect disconnection and short circuits of the plurality of gate signal lines 13 and source signal lines 14, a pixel defect (bright spot, black spot), display nonuniformity, and the like.

<First Lead-Wiring-Line Disconnection Inspection Circuit 35a>

The first lead-wiring-line disconnection inspection circuit 35a provided in the first semiconductor chip mounting region 31a includes two inspection signal lines LOSW, LOCG extended in the X-direction, and a plurality of first lead-wiring-line disconnection inspection semiconductor switching elements (here, a plurality of first lead-wiring-line disconnection inspection TFTs 351a) arrayed in the X-direction.

The inspection signal line LOSW is connected with a terminal OSW, while being connected commonly with the gate electrodes of the plurality of first lead-wiring-line disconnection inspection TFTs 351a.

The inspection signal line LOCG as the first lead-wiring-line disconnection inspection signal line is connected with a terminal OCG, while being connected with the plurality of gate signal lines 13 via the plurality of first lead-wiring-line disconnection inspection TFTs 351a, the plurality of first output terminals 33a, and the plurality of first lead wiring lines 51a.

The plurality of first lead-wiring-line disconnection inspection TFTs 351a can batch-control inputs (non-inputs) of inspection signals from the terminal OCG (inspection signal line LOCG) into the plurality of gate signal lines 13 via the plurality of first output terminals 33a and the plurality of first lead wiring lines 51a in accordance with a gate potential commonly applied from the terminal OSW (inspection signal line LOSW). It is to be noted that the configuration described above is an example and not restricted to this, and the number, an orientation, a shape and the like of constitutional element of the first lead-wiring-line disconnection inspection circuit 35a may be changed as appropriate.

<Second Lead-Wiring-Line Disconnection Inspection Circuit 35b>

The second lead-wiring-line disconnection inspection circuit 35b provided in the second semiconductor chip mounting region 31b includes two inspection signal lines LOSW, LOCS extended in the X-direction, and a plurality of second lead-wiring-line disconnection inspection semiconductor switching elements (here, a plurality of second lead-wiring-line disconnection inspection TFTs 351b) arrayed in the X-direction.

The inspection signal line LOSW is connected with a terminal OSW, while being connected commonly with the gate electrodes of the plurality of second lead-wiring-line disconnection inspection TFTs 351b.

The inspection signal line LOCS as the second lead-wiring-line disconnection inspection signal line is connected with the terminal OCS, while being connected with the plurality of source signal lines 14 via the plurality of second lead-wiring-line disconnection inspection TFTs 351b, the plurality of second output terminals 33b and the plurality of second lead wiring lines 51b.

The plurality of second lead-wiring-line disconnection inspection TFTs 351b can batch-control inputs (non-inputs) of inspection signals from the terminal OCS (inspection signal line LOCS) into the plurality of source signal lines 14 via the plurality of second output terminals 33b and the plurality of second lead wiring lines 51b in accordance with a gate potential commonly applied from the terminal OSW (inspection signal line LOSW). It is to be noted that the configuration described above is an example and not restricted to this, and the number, an orientation, a shape and the like of constitutional element of the second lead-wiring-line disconnection inspection circuit 35b may be changed as appropriate.

According to the first and second lead-wiring-line disconnection inspection circuits 35a, 35b as thus described, when the on-voltage gate potential is applied to the two terminals OSW, the plurality of first and second lead-wiring-line disconnection inspection TFTs 351a, 351b come into an on-state in a batch. In this case, it is possible to respectively input the inspection signals from the terminal OCG into the plurality of gate signal lines 13 via the plurality of first lead wiring lines 51a, and it is possible to respectively input the inspection signals from the terminal OCS to the plurality of source signal lines 14 via the plurality of second lead wiring lines 51b. Therefore, when the inspection signals are inputted into a large number of first and second lead wiring lines 51a, 51b in a batch, by focusing attention on whether or not a blight line astride from one end to the other end of the display region 11 exists (in the case of normally white), it is possible to perform inspection as to whether or not disconnection exists on the first and second lead wiring lines 51a, 51b.

<Drive Conditions at the Time of Inspection>

In the first preferred embodiment, at the time of inspection by use of the first and second lead-wiring-line disconnection inspection circuits 35a, 35b, drive conditions (control conditions) for the plurality of first and second lead-wiring-line disconnection inspection TFTs 351a, 351b are devised, thereby allowing reduction in size of the first and second lead-wiring-line disconnection inspection circuits 35a, 35b. Hereinafter, this will be specifically described in comparison with inspection by use of the first and second lighting inspection circuits 61a, 61b.

It is to be noted that in the following, the inspection performed by use of the first and second lighting inspection circuits 61a, 61b, namely inspection performed by use of the plurality of first and second inspection TFTs 611a, 611b, is referred to as “batch drive display inspection”, and the inspection performed by use of the first and second lead-wiring-line disconnection inspection circuits 35a, 35b, namely inspection performed by use of the plurality of first and second lead-wiring-line disconnection inspection TFTs 351a, 351b, is referred to as “lead-wiring-line disconnection inspection”.

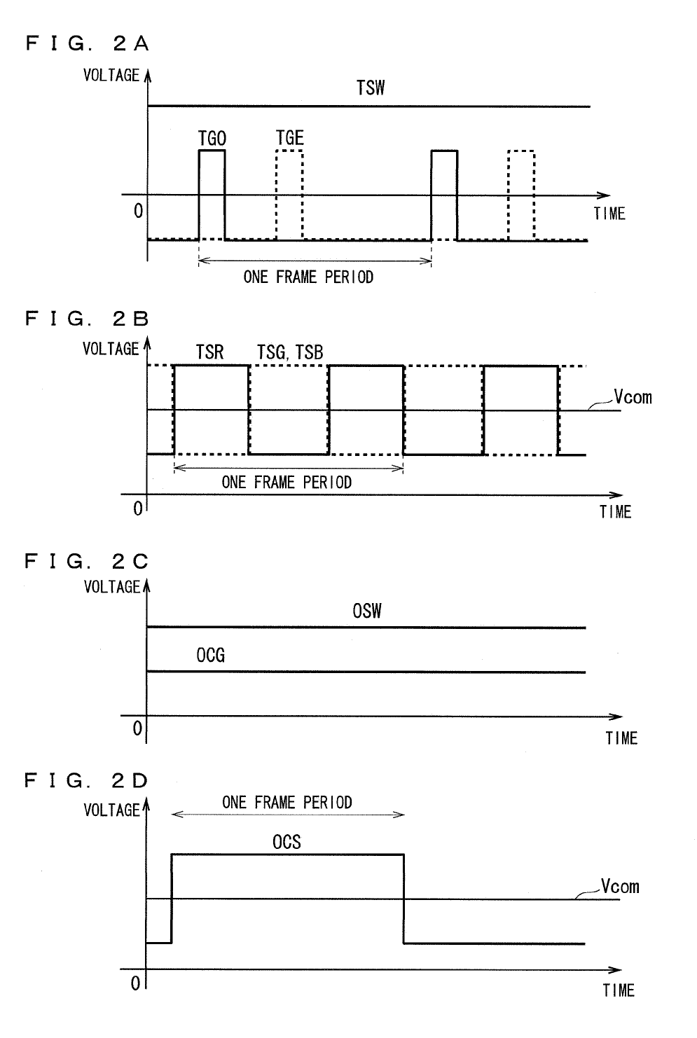

FIGS. 2A and 2B are diagrams each showing the drive conditions (control conditions) for the plurality of first and second inspection TFTs 611a, 611b at the time of performing the batch drive display inspection, and FIGS. 2C and 2D are diagrams each showing the drive conditions (control conditions) for the plurality of first and second lead-wiring-line disconnection inspection TFTs 351a, 351b at the time of performing the lead-wiring-line disconnection inspection. The batch drive display inspection shown in FIGS. 2A and 2B and the lead-wiring-line disconnection inspection shown in FIGS. 2C and 2D are separately performed.

Hereinafter, in order to facilitate descriptions, an inspection signal that is inputted into the terminal TSW will be referred to as an inspection signal TSW, and inspection signals that are inputted into the terminals TGO, TGE, TSR, TSG, TSB, Vcom, OSW, OCG, OCS will also be referred to in the same manner.

As shown in FIGS. 2A and 2B, a drive frequency, a voltage and the like of an inspection signal at the time of performing the batch drive display inspection are set on the basis of drive conditions during use of a product. Specifically, by applying stationary on-voltages shown in FIG. 2A to the terminal TSW, the plurality of first and second inspection TFTs 611a, 611b are brought into an on-state continuously and in a batch manner.

Then, the inspection signals TGO, TGE that alternately apply on-voltages and off-voltages of the display TFT 12 are inputted from the plurality of first inspection TFFs 611a in the on-state into the gate signal lines 13, thereby performing the above batch drive display inspection. Here, a frequency of the on-voltage and values of the on-voltage and the off-voltage are set so as to be equivalent to the conditions during use of the product as described above. In this case, normally, an off-voltage period is set longer than an on-voltage period.

Further, as for the inspection signals TSR, TSG, TSB that are inputted from the plurality of second inspection TFFs 611b in the on-state into the source signal lines 14, the setting is made in accordance with the inspection signals TGO, TGE that are inputted from the plurality of first inspection TFTs 611a into the gate signal lines 13, as shown in FIG. 2B. When TGO is on, TSR has a positive polarity (higher potential than Vcom) and TSG and TSB have negative polarities (lower potential than Vcom), and when TGE is on, TSR has a negative polarity and TSG and TSB have positive polarities. Therefore, a display subjected to pseudo dot-reversal driving can be inspected.

On the other hand, as shown in FIGS. 2C and 2D, a drive frequency, a voltage and the like of an inspection signal at the time of performing the lead-wiring-line disconnection inspection are not set on the basis of drive conditions at the time of using the product. Specifically, by applying stationary on-voltages shown in FIG. 2C to the terminal OSW, the plurality of first and second lead-wiring-line disconnection inspection TFTs 351a, 351b are brought into an on-state continuously and in a batch manner.

Then, the inspection signals OCG that continuously apply on-voltages of the display TFT 12 are inputted from the plurality of first lead-wiring-line disconnection inspection TFTs 351a in the on-state into the gate signal lines 13, thereby performing the above lead-wiring-line disconnection inspection. That is, the inspection signal OCG that is inputted into the gate signal line 13 is set such that only an on-voltage period exists.

Therefore, at the time of the lead-wiring-line disconnection inspection, since signals that are inputted from the plurality of first lead-wiring-line disconnection inspection TFTs 351a into the display TFT 12 via the gate signal lines 13 are DC signals (direct-current signals), there is no need for consideration of charging capacities of the plurality of first lead-wiring-line disconnection inspection TFTs 351a. Hence it is possible to reduce channel widths of the plurality of first lead-wiring-line disconnection inspection TFTs 351a. Specifically, the channel width of each of the first lead-wiring-line disconnection inspection TFTs 351a can be made smaller than the channel width of each of the first inspection TFTs 611a.

Further, since a charging period of the display TFT 12 provided in the display region 11 extends (the charging period continues) by the input of the inspection signal OCG as described above, the charging capacities of the plurality of second lead-wiring-line disconnection inspection TFTs 351b connected to the source signal lines 14 can be reduced. Hence, it is possible to reduce channel widths of the plurality of second lead-wiring-line disconnection inspection TFTs 351b. Specifically, the channel width of each of the second lead-wiring-line disconnection inspection TFTs 351b can be made smaller than the channel width of each of the second inspection TFTs 611b.

Further, on-voltages to gate electrodes of the plurality of second lead-wiring-line disconnection inspection TFTs 351b connected to the source signal lines 14 are preferably set high, an on-voltage of the gate signal line 13 is preferably set high, or a frequency of the source signal is preferably set low. In this case, a similar effect to the foregoing effect is obtained, and it is possible to reduce channel widths of the plurality of second lead-wiring-line disconnection inspection TFTs 351b connected to the source signal lines 14.

Summarizing the above, according to the display device and the inspection method thereof in accordance with the first preferred embodiment, it is possible to reduce the channel widths of the plurality of first and second lead-wiring-line disconnection inspection TFTs 351a, 351b, thereby making the sizes of the TFTs small. Hence, it is possible to make small the sizes of the first and second semiconductor chip mounting regions 31a, 31b provided with the plurality of first and second lead-wiring-line disconnection inspection TFTs 351a, 351b.

Further, at the time of the lead-wiring-line disconnection inspection, an off-voltage gate potential is applied to the terminal TSW such that the first and second inspection TFTs 611a, 611b come into an off-state (not shown). Similarly, at the time of the batch drive display inspection, an off-voltage gate potential is applied to the terminal OSW such that the first and second lead-wiring-line disconnection inspection TFTs 351a, 351b come into an off-state (not shown). This can prevent occurrence of a short circuit and a current leakage via an inappropriate TFT at the time of each inspection.

### Second Preferred Embodiment

A second preferred embodiment of the present invention is a modified example configured on the basis of the foregoing first preferred embodiment.

As described above, in the lead-wiring-line disconnection inspection, attention is focused on whether or not a blight line astride from one end to the other end of the display region 11 exists (in the case of normally white), and not on whether or not the display nonuniformity exists in a pixel display of the display region 11. That is, in the first and second lead-wiring-line disconnection inspection circuits 35a, 35b, it is not necessary to consider the nonuniformity inside the display panel surface caused by resistivity distribution.

In the second preferred embodiment, the wiring line widths of the inspection signal lines LOCG, LOCS are reduced. Specifically, the wiring line width of the inspection signal line LOCG as the first lead-wiring-line disconnection inspection signal line is configured to be smaller than the wiring line widths of the inspection signal lines LTGO, LTGE as the first inspection signal lines. Further, the wiring line width of the inspection signal line LOCS as the second lead-wiring-line disconnection inspection signal line is configured to be smaller than the wiring line widths of the inspection signal lines LTSR, LTSG, LTSB as the second inspection signal lines.

According to the display device in accordance with to the second preferred embodiment as thus configured, it is possible to make small the sizes of the inspection signal lines LOCG, LOCS, thereby making smaller the sizes of the first and second semiconductor chip mounting regions 31a, 31b provided with these signal lines.

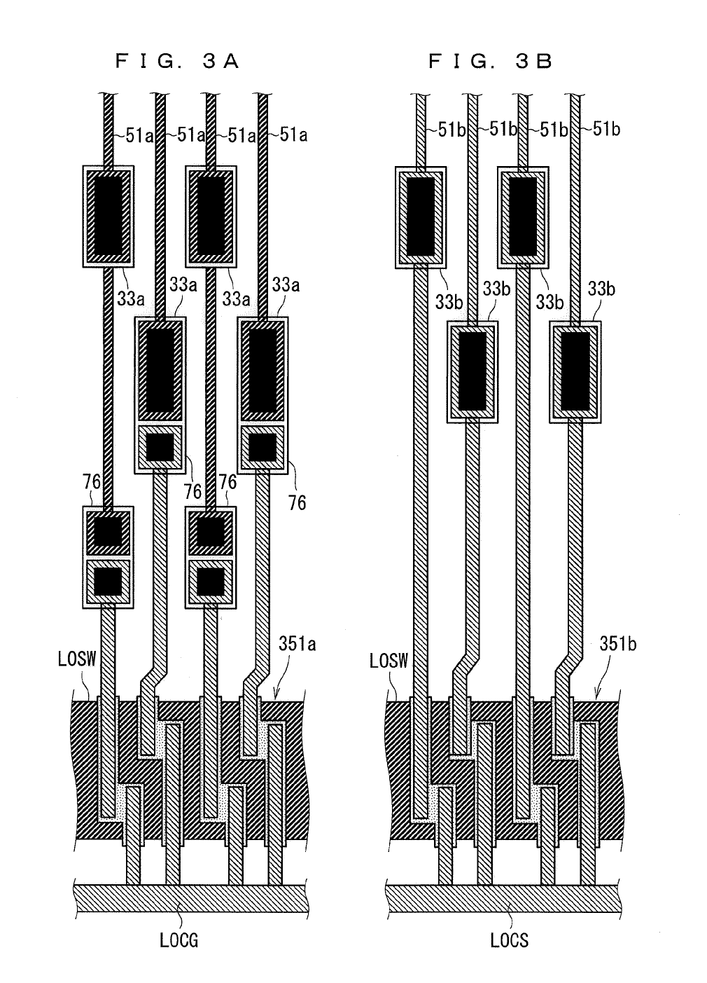

Here, FIGS. 3A and 3B respectively show enlarged plan views of the first and second semiconductor chip mounting regions 31a, 31b according to the second preferred embodiment. Here, the plurality of first and second output terminals 33a, 33b are arrayed in a staggered form along the X-direction so as to make a wiring interval between wiring lines as small as possible.

Incidentally, in FIGS. 3A and 3B, wiring lines made up of a metal film of the same layer are provided with the same hatching, and wiring lines made up of metal films of different layers are provided with different hatching. It means that, for example, the first lead wiring lines 51a and the inspection signal line LOSW are made up of a metal film of a different layer from those of the inspection signal lines LOCG, LOCS. It is to be noted that the signal lines made up of metal films of different layers from each other are electrically connected with each other by a conversion part 76 made up, for example, of a contact plug or the like.

Here, each of the first and second lead-wiring-line disconnection inspection circuits 35a, 35b is provided with one inspection signal line LOCG or LOCS. Therefore, as shown in FIGS. 3A and 3B, the display TFT 12, the first and second inspection TFTs 611a, 611b, the source electrodes and the drain electrodes of the first and second lead-wiring-line disconnection inspection TFTs 351a, 351b, the second lead wiring lines 51b and the inspection signal lines LOCG, LOCS may be made up of the metal film of the same layer. When such a configuration is formed, it is possible to suppress the number of conversion parts 76 in the first and second semiconductor chip mounting regions 31a, 31b, thereby making even smaller the sizes of the first and second semiconductor chip mounting regions 31a, 31b.

### Third Preferred Embodiment

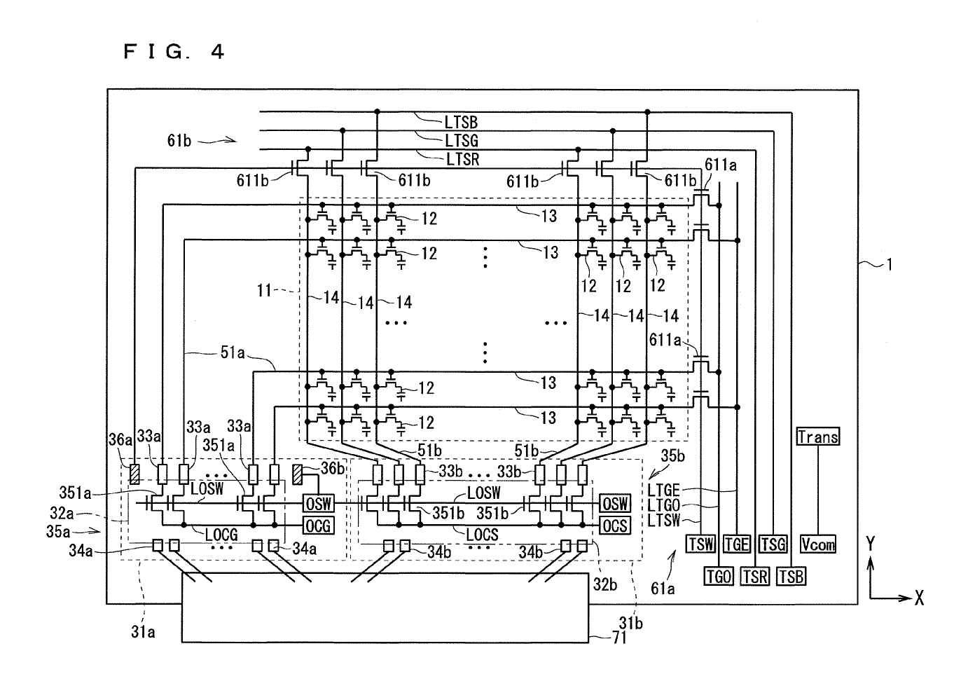

A third preferred embodiment of the present invention is a modified example configured on the basis of the first or second preferred embodiment. FIG. 4 is a circuit diagram showing a configuration of a display device (display panel) according to the third preferred embodiment of the present invention. As shown in FIG. 4, in the third preferred embodiment, off-voltage terminals 36a, 36b are provided in the first semiconductor chip mounting region 31a.

The off-voltage terminal 36a is connected with the inspection signal line LTSW, and common gate potentials can be applied to the plurality of first and second inspection TFTs 611a, 611b via the inspection signal line LTSW.

The off-voltage terminal 36b is connected with the inspection signal line LOSW in the first semiconductor chip mounting region 31a via the terminal OSW, and common gate potentials can be applied to the plurality of first lead-wiring-line disconnection inspection TFTs 351a via the inspection signal line LOSW. It is to be noted that in the example shown in FIG. 4, the inspection signal line LOSW in the first semiconductor chip mounting region 31a is connected with the inspection signal line LOSW in the second semiconductor chip mounting region 31b. According to such a configuration, the off-voltage terminal 36b can apply the common gate potentials to the plurality of first and second lead-wiring-line disconnection inspection TFTs 351a, 351b.

As thus described, in the display device according to the third preferred embodiment as thus configured, off-voltage gate potentials are applied from the gate drive circuit 32a or the drive circuit 71 to the off-voltage terminals 36a, 36b at the time of displaying an image. That is, at the time of the image display, any of the plurality of first and second inspection TFTs 611a, 611b and the first and second lead-wiring-line disconnection inspection TFTs 351a, 351b is applied with the off-voltage gate potential, and any of them comes into an off-state. This can prevent occurrence of a short circuit and a current leakage between the gate signal lines 13 via the first inspection TFT 611a or the first lead-wiring-line disconnection inspection TFT 351a during use of the product, and can similarly prevent occurrence of a short circuit and a current leakage between the source signal lines 14 via the second inspection TFT 611b or the second lead-wiring-line disconnection inspection TFT 351b.

### Fourth Preferred Embodiment

In the display devices according to the first to third preferred embodiments, the plurality of first and second lead-wiring-line disconnection inspection TFTs 351a, 351b were provided. As opposed to this, in a display device according to a fourth preferred embodiment of the present invention, disconnection and the like of the first and second lead wiring lines 51a, 51b can be inspected without providing the plurality of first and second lead-wiring-line disconnection inspection TFTs 351a, 351b. In addition, while the configurations of the first and second semiconductor chip mounting regions 31a, 31b will be described in the following, it is assumed that the other configurations are the same as those in the first to third preferred embodiments (namely, it is assumed that the display device according to the fourth preferred embodiment is also provided with the plurality of first and second inspection TFTs 611a, 611b).

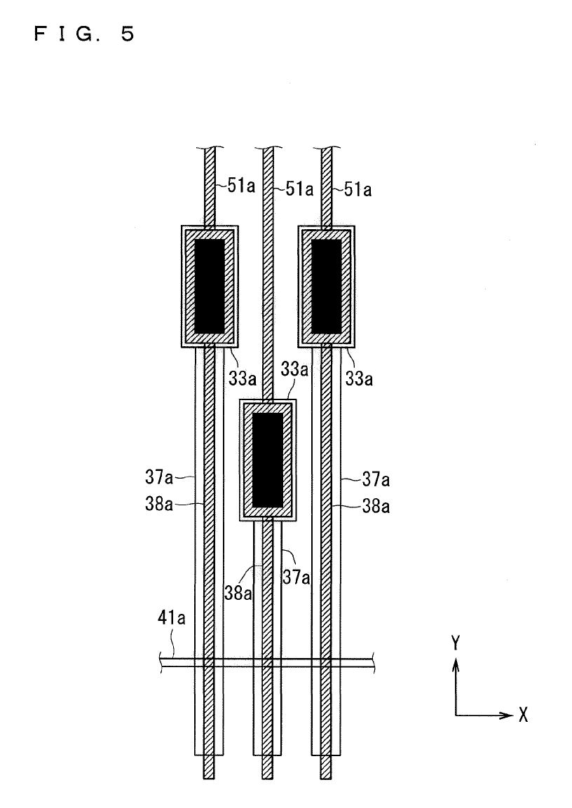

FIG. 5 is an enlarged plan view showing a configuration of the vicinity of the first output terminal 33a in the first semiconductor chip mounting region 31a according to the fourth preferred embodiment. In the first semiconductor chip mounting region 31a shown in FIG. 5, the plurality of first lead-wiring-line disconnection inspection TFTs 351a and the inspection signal lines LOSW, LOCG shown in FIG. 3A are not provided. Instead, in the first semiconductor chip mounting region 31a shown in FIG. 5, a plurality of first inspection terminals 37a electrically connected with the plurality of first output terminals 33a are respectively provided in the opposite direction (Y-direction) to the plurality of first lead wiring lines 51a with respect to the plurality of first output terminals 33a. Then, at least part of the plurality of first inspection terminals 37a (part that is extended in the +Y-direction from −Y-side end of each of the first inspection terminals 37a by the order of 100 μm) are arrayed in a first predetermined direction (X-direction) other than the above opposite direction (Y-direction).

It should be noted that the plurality of first inspection terminals 37a are formed from a transparent conductive film which is the top layer out of a plurality of films laminated on the substrate 1, and any of them is directly connected with the first output terminal 33a. It is to be noted that at least one of an insulating film and a metal film may be formed in a layer under the plurality of first inspection terminals 37a (transparent conductive film). In the example shown in FIG. 5, a configuration is shown where under-layered wiring lines 38a are provided in the layer under an inspection terminal 37a.

In the above, the configuration of the first semiconductor chip mounting region 31a has been described. Meanwhile, although not shown, a configuration of the second semiconductor chip mounting region 31b is similar to the configuration of the first semiconductor chip mounting region 31a. That is, in the second semiconductor chip mounting region 31b, the plurality of second lead-wiring-line disconnection inspection TFTs 351b and the inspection signal lines LOSW, LOCS shown in FIG. 3B are not provided, but a plurality of second inspection terminals 37b electrically connected with the plurality of second output terminals 33b are respectively provided in the opposite direction (Y-direction) to the plurality of second lead wiring lines 51b with respect to the plurality of second output terminals 33b. Then, at least part of the plurality of second inspection terminals 37b (part that is extended in the +Y-direction from −Y-side end of each of the second inspection terminals 37b by the order of 100 μm) are arrayed in a second predetermined direction (X-direction) other than the above opposite direction (Y-direction).

<Inspection Method>

Next, there will be described a method for inspecting disconnection and the like of the first lead wiring lines 51a in the display device configured as above. In the case of performing this inspection, as shown in FIG. 5, at least part of the plurality of first inspection terminals 37a arrayed in the first predetermined direction (X-direction) is simultaneously connected with one first inspection needle 41a having a blade shape astride these. Then, inspection signals are inputted in a batch from the first inspection needle 41a into the plurality of gate signal lines 13 via the plurality of first lead wiring lines 51a. Here, for example, DC signals (direct-current signals) are inputted as the inspection signals into the plurality of gate signal lines 13.

Similarly, although not shown, at least part of the plurality of second inspection terminals 37b arrayed in the second predetermined direction (X-direction) is simultaneously connected with one second inspection needle 41b having a blade shape astride these, and inspection signals are inputted in a batch from the second inspection needle 41b into the plurality of source signal lines 14 via the plurality of second lead wiring lines 51b. Here, for example in the case of normally white, AC signals (alternate-current signals) capable of making black displays are inputted as the inspection signals into the plurality of source signal lines 14.

According to the display device and the inspection method thereof according to the fourth preferred embodiment as above, it is possible to probe the plurality of first lead wiring lines Ma in a batch by the first inspection needle 41a, and also possible to probe the plurality of second lead wiring lines 51b in a batch by the second inspection needle 41b. Therefore, since the plurality of first and second lead-wiring-line disconnection inspection TFTs 351a, 351b and the inspection signal lines LOSW, LOCG, LOCS described in the first preferred embodiment and the like do not need to be provided, it is possible to expect reduction in sizes of the first and second semiconductor chip mounting regions 31a, 31b.

Further, even when the bump pitches in the semiconductor chips (the gate drive circuit 32a, the source drive circuit 32b) are further narrowed, the first and second inspection needles 41a, 41b do not need to be made finer accordingly, and hence it is possible to expect generalization of the inspection method.

In addition, the tops of the plurality of first and second inspection terminals 37a, 37b are preferably located at the same position in a height direction in a cross sectional view. When such a configuration is formed, it is possible to suppress separation of the first and second inspection needles 41a, 41b from the first and second inspection terminals 37a, 37b at the time of probing by the first and second inspection needles 41a, 41b, thereby improving the stability of the probing.

### Fifth Preferred Embodiment

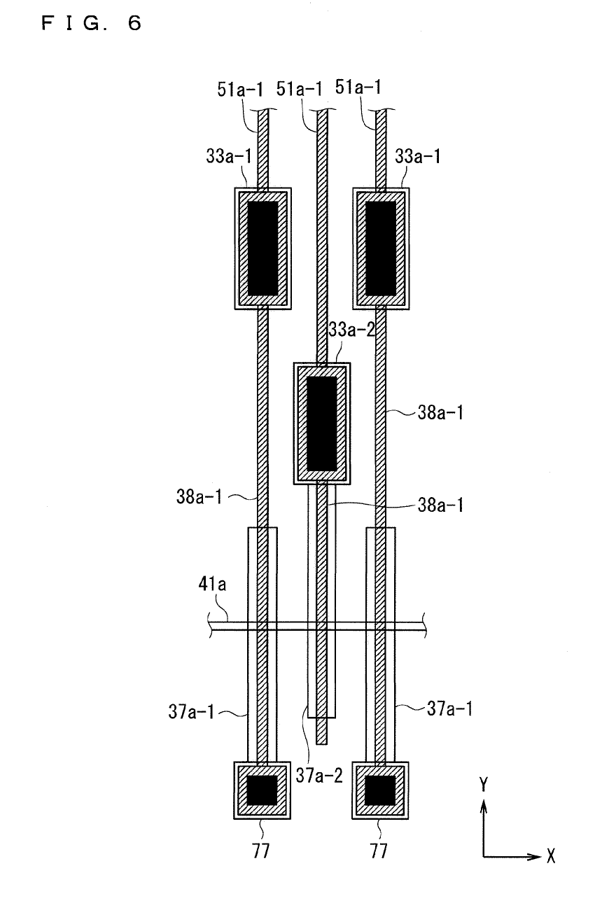

A fifth preferred embodiment of the present invention is a modified example configured on the basis of the fourth preferred embodiment. FIG. 6 is an enlarged plan view showing a configuration of the vicinity of the first output terminal 33a in the first semiconductor chip mounting region 31a according to the fifth preferred embodiment. It is to be noted that, although not shown, a configuration of the second semiconductor chip mounting region 31b is similar to the configuration of the first semiconductor chip mounting region 31a.

In the configuration described in the fourth preferred embodiment (configuration shown in FIG. 5), a distance between one of the first output terminals 33a and the first inspection terminal 37a adjacent thereto is close. It is considered that, when the pitches are narrowed in such a configuration, a short circuit may occur due to variations in production, to lower a yield.

Therefore, in the fifth preferred embodiment, as shown in FIG. 6, arbitrary two adjacent first output terminals 33a-1, 33a-2 are configured such that the one first output terminal 33a-2 is located at an adjacent position corresponding to a space between the other first output terminal 33a-1 and a first inspection terminal 37a-1 electrically connected therewith.

It is to be noted that in the example shown in this FIG. 6, the first output terminal 33a-1 is connected with an under-layered wiring line 38a-1 which is a layer under the first output terminal 33a-1 and is extended in the Y-direction for example by a contact plug or the like which is not shown, and the under-layered wiring line 38a-1 is connected with the first inspection terminal 37a-1 by a conversion part 77 for example made of a contact plug or the like. With this configuration, the first output terminal 33a-1 is electrically connected with the first inspection terminal 37a-1.

According to the display device in accordance with the fifth preferred embodiment as above, it is possible to ensure a distance between the first output terminal 33a-2 and the first inspection terminal 37a-1 to be not shorter than 5 μm, for example, thereby suppressing lowering of the yield due to a short circuit.

It is to be noted that in the present invention, the respective preferred embodiments can be freely combined, or can be modified or omitted as appropriate within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a substrate provided with a display region and semiconductor chip mounting regions,
wherein
said display region is provided with
a plurality of semiconductor switching elements,
a plurality of gate signal lines connected with gate electrodes of said plurality of semiconductor switching elements, and
a plurality of source signal lines connected with source electrodes of said plurality of semiconductor switching elements,
said semiconductor chip mounting regions are provided with
a plurality of first output terminals and a plurality of second output terminals which are output terminals connected with semiconductor chips and are respectively connected with said plurality of gate signal lines and said plurality of source signal lines via a plurality of first and second lead wiring lines,
said display device includes
a plurality of first inspection semiconductor switching elements which are provided on said substrate other than said display region and said semiconductor chip mounting regions and can batch-control inputs of inspection signals into said plurality of gate signal lines in accordance with a commonly applied gate potential,
a plurality of second inspection semiconductor switching elements which are provided on said substrate other than said display region and said semiconductor chip mounting regions and can batch-control inputs of inspection signals into said plurality of source signal lines in accordance with a commonly applied gate potential,
a plurality of first lead-wiring-line disconnection inspection semiconductor switching elements which are provided in said semiconductor chip mounting region and can batch-control inputs of inspection signals into said plurality of gate signal lines via said plurality of first output terminals and said plurality of first lead wiring lines in accordance with a commonly applied gate potential, and
a plurality of second lead-wiring-line disconnection inspection semiconductor switching elements which are provided in said semiconductor chip mounting region and can batch-control inputs of inspection signals into said plurality of source signal lines via said plurality of second output terminals and said plurality of second lead wiring lines in accordance with a commonly applied gate potential,
wherein a channel width of each of said first lead-wiring-line disconnection inspection semiconductor switching elements is smaller than a channel width of each of said first inspection semiconductor switching elements, and a channel width of each of said second lead-wiring-line disconnection inspection semiconductor switching elements is smaller than a channel width of each of said second inspection semiconductor switching elements.

2. The display device according to claim 1, further comprising:
a first inspection signal line connected with said plurality of gate signal lines via said plurality of first inspection semiconductor switching elements;
a second inspection signal line connected with said plurality of source signal lines via said plurality of second inspection semiconductor switching elements;
a first lead-wiring-line disconnection inspection signal line connected with said plurality of gate signal lines via said plurality of first lead-wiring-line disconnection inspection semiconductor switching elements and said plurality of first lead wiring lines; and
a second lead-wiring-line disconnection inspection signal line connected with said plurality of source signal lines via said plurality of second lead-wiring-line disconnection inspection semiconductor switching elements and said plurality of second lead wiring lines,
wherein a wiring line width of said first lead-wiring-line disconnection inspection signal line is smaller than a wiring line width of said first inspection signal line, and a wiring line width of said second lead-wiring-line disconnection inspection signal line is smaller than a wiring line width of said second inspection signal line.

3. The display device according to claim 1, wherein at the time of displaying an image in said display device, an off-voltage gate potential is applied to any of said plurality of first and second inspection semiconductor switching elements and said plurality of first and second lead-wiring-line disconnection inspection semiconductor switching elements.

4. An inspection method of a display device having a substrate provided with a display region and semiconductor chip mounting regions, wherein
said display region is provided with
a plurality of semiconductor switching elements,
a plurality of gate signal lines connected with gate electrodes of said plurality of semiconductor switching elements, and
a plurality of source signal lines connected with source electrodes of said plurality of semiconductor switching elements,
said semiconductor chip mounting regions are provided with
a plurality of first output terminals and a plurality of second output terminals which are output terminals connected with semiconductor chips and are respectively connected with said plurality of gate signal lines and said plurality of source signal lines via a plurality of first and second lead wiring lines,
said display device includes
a plurality of first inspection semiconductor switching elements which are provided on said substrate other than said display region and said semiconductor chip mounting regions and can batch-control inputs of inspection signals into said plurality of gate signal lines in accordance with a commonly applied gate potential,
a plurality of second inspection semiconductor switching elements which are provided on said substrate other than said display region and said semiconductor chip mounting regions and can batch-control inputs of inspection signals into said plurality of source signal lines in accordance with a commonly applied gate potential,
a plurality of first lead-wiring-line disconnection inspection semiconductor switching elements which are provided in said semiconductor chip mounting region and can batch-control inputs of inspection signals into said plurality of gate signal lines via said plurality of first output terminals and said plurality of first lead wiring lines in accordance with a commonly applied gate potential, and
a plurality of second lead-wiring-line disconnection inspection semiconductor switching elements which are provided in said semiconductor chip mounting region and can batch-control inputs of inspection signals into said plurality of source signal lines via said plurality of second output terminals and said plurality of second lead wiring lines in accordance with a commonly applied gate potential,
wherein a channel width of each of said first lead-wiring-line disconnection inspection semiconductor switching elements is smaller than a channel width of each of said first inspection semiconductor switching elements, and a channel width of each of said second lead-wiring-line disconnection inspection semiconductor switching elements is smaller than a channel width of each of said second semiconductor switching elements,
said inspection method of the display device comprising the steps of:
(a) inputting, from said plurality of first inspection semiconductor switching elements to said gate signal lines, inspection signals that alternately apply on-voltages and off-voltages of said semiconductor switching elements provided in said display region, to perform inspection by use of said plurality of first and second inspection semiconductor switching elements; and
(b) inputting, from said plurality of first lead-wiring-line disconnection inspection semiconductor switching elements to said gate signal lines, inspection signals that continuously apply on-voltages of said semiconductor switching elements provided in said display region, to perform inspection by use of said plurality of first and second lead-wiring-line disconnection inspection semiconductor switching elements.

5. A display device comprising:
a substrate provided with a display region and semiconductor chip mounting regions,
wherein
said display region is provided with
a plurality of semiconductor switching elements,
a plurality of gate signal lines connected with gate electrodes of said plurality of semiconductor switching elements, and
a plurality of source signal lines connected with source electrodes of said plurality of semiconductor switching elements,
said semiconductor chip mounting regions are provided with
a plurality of first output terminals and a plurality of second output terminals which are output terminals connected with semiconductor chips and are respectively connected with said plurality of gate signal lines and said plurality of source signal lines via a plurality of first and second lead wiring lines, and
a plurality of first and second inspection terminals which are respectively electrically connected with said plurality of first and second output terminals and are respectively provided in the opposite directions to said plurality of first and second lead wiring lines with respect to said plurality of first and second output terminals,
wherein at least part of said plurality of first inspection terminals is arrayed in a first predetermined direction other than said opposite direction, and at least part of said plurality of second inspection terminals is arrayed in a second predetermined direction other than said opposite direction,
said display device includes
a plurality of first inspection semiconductor switching elements which are provided on said substrate other than said display region and said semiconductor chip mounting regions and can batch-control inputs of inspection signals into said plurality of gate signal lines in accordance with a commonly applied gate potential, and
a plurality of second inspection semiconductor switching elements which are provided on said substrate other than said display region and said semiconductor chip mounting regions and can batch-control inputs of inspection signals into said plurality of source signal lines in accordance with a commonly applied gate potential.

6. The display device according to claim 5, wherein the tops of said plurality of first and second inspection terminals are located at the same position in a height direction in a cross sectional view.

7. The display device according to claim 5, wherein, as for arbitrary two adjacent output terminals out of said plurality of first and second output terminals, the one output terminal is located at an adjacent position corresponding to a space between the other output terminal and said inspection terminal electrically connected therewith.

8. An inspection method of a display device having a substrate provided with a display region and semiconductor chip mounting regions,
wherein
said display region is provided with
a plurality of semiconductor switching elements,
a plurality of gate signal lines connected with gate electrodes of said plurality of semiconductor switching elements, and
a plurality of source signal lines connected with source electrodes of said plurality of semiconductor switching elements,
said semiconductor chip mounting regions are provided with
a plurality of first output terminals and a plurality of second output terminals which are output terminals connected with semiconductor chips and are respectively connected with said plurality of gate signal lines and said plurality of source signal lines via a plurality of first and second lead wiring lines, and
a plurality of first and second inspection terminals which are respectively electrically connected with said plurality of first and second output terminals and are respectively provided in the opposite directions to said plurality of first and second lead wiring lines with respect to said plurality of first and second output terminals,
wherein at least part of said plurality of first inspection terminals is arrayed in a first predetermined direction other than said opposite direction, and at least part of said plurality of second inspection terminals is arrayed in a second predetermined direction other than said opposite direction,
said display device includes
a plurality of first inspection semiconductor switching elements which are provided on said substrate other than said display region and said semiconductor chip mounting regions and can batch-control inputs of inspection signals into said plurality of gate signal lines in accordance with a commonly applied gate potential, and
a plurality of second inspection semiconductor switching elements which are provided on said substrate other than said display region and said semiconductor chip mounting regions and can batch-control inputs of inspection signals into said plurality of source signal lines in accordance with a commonly applied gate potential,
the inspection method of said display device comprising the steps of:
(a) inputting, from said plurality of first inspection semiconductor switching elements to said gate signal lines, inspection signals that alternately apply on-voltages and off-voltages of said semiconductor switching elements provided in said display region, to perform inspection by use of said plurality of first and second inspection semiconductor switching elements; and
(b) simultaneously connecting said at least part of said plurality of first inspection terminals arrayed in said first predetermined direction with one first inspection needle astride these to batch-input inspection signals from the first inspection needle into said plurality of gate signal lines via said plurality of first lead wiring lines, while with simultaneously connecting said at least part of said plurality of second inspection terminals arrayed in said second predetermined direction with one second inspection needle astride these to batch-input inspection signals from the second inspection needle into said plurality of source signal lines via said plurality of second lead wiring lines, for performing inspection.
